(19) United States
(12) Patent Application Publication
(10) Pub. No.: US 2004/0061091 A1
(43) Pub. Date: Apr. 1, 2004

(54) Refrigerant blend

(76) Inventor: James B. Tieken, Henderson, NV (US)

Correspondence Address: BRINKS HOFER GILSON & LIONE, ONE INDIANA SQUARE, SUITE 1600, INDIANAPOLIS, IN, 46204-2033, US

(21) Appl. No.: 10/672,505

(22) Filed: Sep. 26, 2003

Related U.S. Application Data
(60) Provisional application No. 60/415,340, filed on Oct. 1, 2002.

(51) Int. Cl. F25D 1/00; C09K 5/00

(52) U.S. Cl. 252/67

(57) ABSTRACT

A refrigerant blend to replace refrigerant R-22 (chlorodifluoromethane) in refrigeration systems designed to use R-22 as the refrigerating fluid. The inventive refrigerant blend comprises R-134a (1,1,1,2-tetrafluoroethane), R-125 (pentafluoroethane), a hydrocarbon component, and, optionally, R-32 (difluoromethane). The hydrocarbon component comprises at least two hydrocarbons having boiling points that bracket the boiling point of R-134a (−15° F., −26° C.). The hydrocarbons in one group, designated as Group A, have boiling points lower than the boiling point of R-134a. The hydrocarbons in the other group, designated Group B, have boiling points higher than that of R-134a.

### RELATED APPLICATIONS

The present document claims the benefit of the filing date under 35 U.S.C. § 119(e) of co-pending Provisional U.S. Patent Application Serial No. 60/415,340, filed Oct. 1, 2002.

### BACKGROUND

This invention relates generally to novel refrigerant blends that can be used to replace chlorofluorocarbon (CFC) and hydrochlorofluorocarbon (HCFC) refrigerants. More particularly, the invention relates to novel refrigerant blends that can be used to replace R-22 (chlorodifluoromethane) in refrigeration systems designed to use R-22 as the refrigerating fluid.

Refrigeration systems have been in widespread use for decades. Refrigeration systems have a wide variety of uses, such as comfort cooling, household refrigeration, automobile air conditioning, commercial freezer cooling, and the like. Such systems work on the basic premise that a fluid, known as a refrigerant, picks up heat from an area to be refrigerated, and disposes of the heat in an area not adversely affected by an increase in heat. Typically, refrigeration processes encompass a changing state of the refrigerant fluid from a liquid to a vapor, and from a vapor to a liquid, which change of state allows for the rapid removal of heat from the area to be refrigerated. Different types of refrigeration systems use different refrigerants having properties designed to enable the given system to approach peak performance.

Chlorofluorocarbon refrigerants such as R-12 (dichlorodifluoromethane) were the refrigerants of choice for many years in domestic and commercial refrigeration, as well as in automobile air conditioners. However, in view of the recognition in the scientific community that these chlorine-containing refrigerants have an adverse effect on the earth's ozone layer, international agreements have mandated a phase-out of these refrigerants in favor of more environmentally friendly refrigerants. Hydrochlorofluorocarbon refrigerants such as R-22, while believed to be less environmentally problematic than CFCs, are also chlorine-containing, and have likewise raised concerns in the scientific community. International agreements have called for a gradual phase-out of HCFC refrigerants.

Numerous low ozone-depleting refrigerants have been promoted as replacement refrigerants. A widely used replacement refrigerant has been R-134a (1,1,1,2-tetrafluoroethane). R-134a contains no chlorine atoms, and is non-ozone-depleting, non-flammable and non-toxic. However, the use of R-134a necessitates major changes in most refrigeration systems. For example, the mineral oil lubricants typically used with CFC and HCFC refrigerants are not compatible with R-134a. As a result, it is necessary to completely drain this oil from systems previously using CFC and HCFC refrigerants, and replace it with other lubricants that are more compatible with R-134a, such as polyolester (POE) and polyalkylene glycol (PAG) lubricants. In addition, some equipment used in existing air conditioning systems is not compatible with R-134a, thus necessitating significant overhaul and replacement of portions of these air conditioning systems.

When new products are designed and/or put into service, such products can be engineered for use with new refrigerants such as R-134a. Thus, such products can be manufactured with components that are compatible with R-134a, and can be produced for use with compatible lubricating oils. However, the situation is more problematic when existing refrigeration systems require replacement refrigerant. Replacements are often required when, for example, existing refrigerant is leaked or evaporated from the system. Replacement refrigerant also must be periodically added to such systems during routine maintenance of the system. In existing refrigeration systems, it is often cost prohibitive to retrofit the system to be compatible with non-CFC or non-HCFC refrigerants such as R-134a. In addition, in small systems it is often inconvenient and uneconomical to completely drain the existing lubricant and replace it with a lubricating oil that is more compatible with a replacement refrigerant.

Several refrigerant compositions that are intended to replace R-22 are commercially available. The three best known replacement refrigerants are R-407C (a combination of R-134a, R-125, and R-32), R-410A (a binary blend of R-125 and R-32), and R-417A (a blend of R-125, R-134a, and R-600). R-410A is a high pressure refrigerant that cannot be used in existing R-22 equipment. As a result, the existing refrigeration equipment must be replaced when this refrigerant is used. R-407C can be used in existing R-22 systems, however, this refrigerant is not compatible with the mineral oil lubricants used in such systems. As a result, the system must be flushed, and the lubricant must be replaced with one that is compatible. R-417A can be used in existing R-22 systems with existing oils. However, this refrigerant shows a decrease in refrigerating capacity of from about 5 to 15 percent when compared to R-22.

Thus, it would be beneficial if an R-22 replacement refrigerant could be provided that can be directly added to the refrigeration system in place of the R-22 refrigerant, without the necessity of draining the existing lubricant and/or overhauling the existing refrigeration equipment to make it compatible with a new refrigerant. Preferably, the replacement refrigerant would be low cost, have low flammability and toxicity, have refrigerating capacity similar to the existing refrigerant, be compatible with the existing system and lubricant, and have the ability to substantially resist fractionation into flammable components upon evaporation or leakage from the refrigeration system.

### SUMMARY

The present invention addresses the problems of the prior art by providing novel refrigerant compositions that may be used in place of CFC and HCFC refrigerants. The inventive refrigerant compositions may be substituted for an existing refrigerant without the necessity of draining the lubricating oil and/or altering the refrigeration system. In addition, the inventive refrigerant compositions are non-flammable, both as originally placed in the refrigeration system, and after 99% of the refrigerant has leaked from the system. The inventive compositions have a refrigerating capacity similar to that of the refrigerants that are replaced, and are non-ozone depleting and non-toxic.

In one form thereof, the present invention comprises a refrigeration composition comprising 1,1,1,2-tetrafluoroethane (R-134a) in an amount of about 20-60%, preferably 30-50%, more preferably 45-50%, and most preferably 47%; pentafluoroethane (R-125) in an amount of about 40-70%, preferably 45-60%, more preferably 45-50%, and most preferably 47%; difluoromethane (R-32) in an amount of about 1-10%, preferably 2-6%, more preferably 3-5%, and most preferably 4%; and a hydrocarbon component in the amount of 1-8%, preferably 1-5%, and more preferably 1-4%. The hydrocarbon component comprises one or more hydrocarbons selected from Group A and one or more hydrocarbons selected from Group B, wherein Group A comprises hydrocarbon refrigerants having a boiling point lower than the boiling point of R-134a and Group B comprises hydrocarbon refrigerants having a boiling point higher than the boiling point of R-134a. Preferably the hydrocarbon component comprises one or more Group A hydrocarbons selected from the group consisting of R-290, R-1270, R-170 and R-50, and one or more Group B hydrocarbons comprising one or more hydrocarbons selected from the group consisting of R-600a, R-600 and R-601; more preferably, the hydrocarbon component comprises R-290 and R-600a; still more preferably the hydrocarbon component comprises R-290 and R-600a in a combined amount of about 1-4% wherein the percentages of each of the hydrocarbon components are the same or do not differ from one another by more than about 1%; and most preferably 1.5% R-290 and 1.5% R-600a. In another form, the invention comprises a composition consisting essentially of the above components.

In another form thereof, the invention comprises a method for producing refrigeration in a refrigeration system comprising employing as a refrigerant a composition as described in the preceding paragraph.

In yet another form thereof, the present invention comprises a refrigerant composition comprising 1,1,12-tetrafluoroethane (R-134a) in an amount of about 20-60%; preferably 30-50%; more preferably 40-50%; and most preferably 45%; pentafluoroethane (R-125) in an amount of about 40-70%; preferably 45-60%; more preferably 50-55%; and most preferably 52%; and a hydrocarbon component in the amount of 1-8%, preferably 1-5%, and more preferably 1-4%. The hydrocarbon component comprises one or more hydrocarbons selected from Group A and one or more hydrocarbons selected from Group B, wherein Group A comprises hydrocarbon refrigerants having a boiling point lower than the boiling point of R-134a and Group B comprises hydrocarbon refrigerants having a boiling point higher than the boiling point of R-134a. Preferably the hydrocarbon component comprises one or more Group A hydrocarbons selected from the group consisting of R-290, R-1270, R-170 and R-50, and one or more Group B hydrocarbons selected from the group consisting of R-600a, R-600 and R-601; more preferably, the hydrocarbon component comprises R-290 and R-600a; still more preferably the hydrocarbon component comprises R-290 and R-600a in a combined amount of about 1-4% wherein the percentages of each of the hydrocarbon components are the same or do not differ from one another by more than about 1%; and most preferably 1.5% R-290 and 1.5% R-600a. In another form, the invention comprises a composition consisting essentially of the above components.

In still another form thereof, the invention comprises a method for producing refrigeration in a refrigeration system comprising employing as a refrigerant a composition described in the preceding paragraph.

### DETAILED DESCRIPTION

For purposes of promoting an understanding of the principles of the present invention, reference will now be made to the preferred embodiments described below, and specific language will be used to describe the same. It will nevertheless be understood that no limitation of the scope of the invention is thereby intended, such alterations and further modifications in the described embodiments, and such further applications of the principles of the invention as described therein being contemplated as would normally occur to one skilled in the art to which the invention pertains.

The present invention teaches novel refrigerant blends comprising the refrigerants pentafluoroethane (R-125), 1,1,1,2-tetrafluoroethane (R-134a), a hydrocarbon component, and, optionally, difluoromethane (R-32). The refrigerant blends may be used in place of CFC and HCFC refrigerants, and particularly, may be used in place of refrigerant R-22. The inventive refrigerant blends are substantially non-toxic, non-ozone-depleting, compatible with refrigeration compressor lubricating oils presently in use, and have refrigerating properties that are substantially the same as, or better than, the properties of the refrigerant that it is replacing. In addition, the inventive refrigerant compositions are non-flammable, both as originally placed in the refrigeration system, and after 99% of the refrigerant has leaked from the system.

The inventive refrigerant blends utilize a unique combination of non-ozone-depleting refrigerants. Components utilized in the inventive blend include R-125, R-134a, a hydrocarbon component, and, optionally, R-32. The hydrocarbon component comprises at least two hydrocarbons having boiling points that bracket the boiling point of R-134a (−15° F., −26° C.). The hydrocarbons in one group, designated as Group A, have boiling points lower than the boiling point of R-134a. The hydrocarbons in the other group, designated Group B, have boiling points higher than that of R-134a. Preferred hydrocarbons in Group A include propane (R-290) (b. pt. −44° F., −42° C.), propylene (R-1270) (b. pt. −54° F., −48° C.), ethane (R-170) (b. pt. −128° F., −89° C.) and methane (R-50) (b. pt. −259° F., −161° C.), with propane being particularly preferred. Preferred hydrocarbons in Group B include isobutane (R-600a) (b. pt. 11° F., −12° C.), butane (R-600) (b. pt. 31° F., 0° C.) and pentane (R-601) (b. pt. 96° F., 36° C.), with isobutane being particularly preferred. Preferably, the hydrocarbon(s) of group A has a boiling point that differs from the boiling point of the hydrocarbon(s) of Group B by at least 40° F., and more preferably, by at least 50° F.

Two particularly preferred embodiments of the inventive refrigerant blend are described below. The components are identified, along with the proportions, by weight percent of the components in the overall refrigerant blend.

Blend 1

(a) R-134a in an amount of about 20-60%; preferably 30-50%; more preferably 45-50%, and most preferably 47%;

(b) R-125 in an amount of about 40-70%; preferably 45-60%; more preferably 45-50%, and most preferably 47%;

(c) R-32 in an amount of about 1-10%; preferably 2-6%; more preferably 3-5%;

and most preferably 4%; and

(d) a hydrocarbon component in an amount of about 1-8%, the hydrocarbon component comprising one or more hydrocarbons selected from Group A and one or more hydrocarbons selected from Group B, wherein Group A comprises hydrocarbon refrigerants having a boiling point lower than the boiling point of R-134a and Group B comprises hydrocarbon refrigerants having a boiling point higher than the boiling point of R-134a; preferably about 1-5% of a hydrocarbon component wherein the hydrocarbons of Group A comprise one or more hydrocarbons selected from the group consisting of R-290, R-1270, R-170 and R-50, and the hydrocarbons of Group B comprise one or more hydrocarbons selected from the group consisting of R-600a, R-600 and R-601; more preferably, the hydrocarbon component comprises R-290 and R-600a; still more preferably the hydrocarbon component comprises R-290 and R-600a in a combined amount of about 1-4% wherein the percentages of each of the hydrocarbon components are the same or do not differ from one another by more than about 1%; and most preferably 1.5% R-290 and 1.5% R-600a.

Blend 2

(a) R-134a in an amount of about 20-60%; preferably 30-50%; more preferably 40-50%; and most preferably 45%;

(b) R-125 in an amount of about 40-70%; preferably 45-60%; more preferably 50-55%; and most preferably 52%; and

(c) a hydrocarbon component in an amount of about 1-8%, the hydrocarbon component comprising one or more hydrocarbons selected from Group A and one or more hydrocarbons selected from Group B, wherein Group A comprises hydrocarbon refrigerants having a boiling point lower than the boiling point of R-134a and Group B comprises hydrocarbon refrigerants having a boiling point higher than the boiling point of R-134a; preferably about 1-5% of a hydrocarbon component wherein the hydrocarbons of Group A comprise one or more hydrocarbons selected from the group consisting of R-290, R-1270, R-170 and R-50, and the hydrocarbons of Group B comprise one or more hydrocarbons selected from the group consisting of R-600a, R-600 and R-601; more preferably, the hydrocarbon component comprises R-290 and R-600a; still more preferably the hydrocarbon component comprises R-290 and R-600a in a combined amount of about 1-4% wherein the percentages of each of the hydrocarbon components are the same or do not differ from one another by more than about 1%; and most preferably 1.5% R-290 and 1.5% R-600a.

The primary difference between Blend 2 and Blend 1 is the lack of R-32 (difluoromethane) in Blend 2. R-32 is considered a very favorable refrigerant insofar as increasing the coefficient of performance (COP) of the total blend is concerned. However, R-32 is also slightly flammable. Since R-32 is slightly flammable, the amount of R-32 in Blend 1 is kept under the amount that would cause this blend to become flammable, taking into account the fact that a hydrocarbon component is also included in the blend. To compensate for the loss of refrigeration capacity due to the omission of R-32 in Blend 2, a refrigerant according to Blend 2 may include a somewhat higher percentage of R-125 than a refrigerant according to Blend 1.

Those skilled in the art will recognize that the proportions of each of the listed ingredients may be varied within the general ranges provided, as long as the variations are not so substantial that the benefits of the invention cannot be achieved. For example, in some embodiments, the amount of R-134a may equal or exceed that of R-125, as long as the percentages of each component remain within the ranges provided above. The amounts of the components should not be varied in a manner such that the operating characteristics of the refrigeration system and/or the flammability, toxicity and ODP (ozone depleting potential) are adversely affected to any significant degree. Processes for mixing refrigerant components to arrive at a refrigerant blend are well known in the refrigerant art, and no special techniques are required to prepare the inventive blends.

It has been well documented that a small amount of a hydrocarbon component in a refrigerant blend can greatly increase the miscibility of compressor lubrication oils commonly found in refrigeration systems, such as R-22 systems. In some systems, as little as 1% of a hydrocarbon component provides sufficient miscibility to enable satisfactory oil return to the compressor. The R-417A blend described above contains about 3% R-600 (n-butane), and is miscible with mineral oil lubricants. A disadvantage of using butane is that its boiling point (about 31° F., −0.6° C.) is higher than the evaporator temperature of most R-22 refrigerating systems such as air conditioning systems, where the evaporator temperature is normally between about 25 and 30° F. (between −4 and 1.1° C.). Since most of the refrigeration occurs when the refrigerant changes state from a liquid to a vapor, the butane does not contribute to the refrigerating effect because it does not boil at these temperatures. Testing by the inventor has determined that propane, which has a boiling point of −44° F. (−42° C.), is probably the best hydrocarbon for refrigerating effect. Isobutane is also favorable, although it has a higher boiling point (11° F., −12° C.) than propane.

When the concentration of the hydrocarbon component of the present refrigerant blend exceeds about 2.5% by weight of the total blend, the refrigerant has a miscibility similar to that of R-22 in mineral-based compressor lubricating oil. However, a difficulty with using a low-boiling single hydrocarbon such as propane as the sole hydrocarbon is that when the percentage of propane in the blend exceeds about 2.5%, the amount of propane in the vapor phase may give rise to flammability problems. As refrigerant leaks out of the system or container, the percentage of propane in the liquid phase goes down, due to the higher concentration of propane vapor leaving the system. When a higher boiling hydrocarbon such as isobutane is used as the hydrocarbon component, the effect is substantially reversed. In this case, the amount of isobutane in the vapor phase starts off at a low level and gets slightly higher as refrigerant is leaked out of the system. The amount of isobutane in the liquid phase initially remains high. However, if a combination of these two refrigerants is used as the hydrocarbon component, the effects of the two refrigerants tend to balance themselves out such that the refrigerant remaining in each phase after leakout never exceeds the flammability limit.

To take advantage of the disparate effects exhibited by certain hydrocarbons, a combination of Group A and Group B hydrocarbons is utilized as the hydrocarbon component. The type and amount of the various hydrocarbons that make up the hydrocarbon component are selected such that the percentage of the hydrocarbon component in the refrigerant blend does not appreciably change as refrigerant leaks out of the system, and therefore does not cause the hydrocarbon component of either the vapor or liquid phase to exceed the flammability limit. A combination of propane and isobutane as the hydrocarbon component has been found to be particularly advantageous in this regard. The propane/isobutane combination is particularly advantageous because it not only maintains a relatively constant level as the refrigerant leaks out of the system, but it also adds significant refrigerating effect to the refrigerant blend when compared to refrigerant blends using various higher boiling hydrocarbons. Additional Group A and/or Group B refrigerants may be added, or substituted, for propane and/or isobutane as long as the hydrocarbon(s) selected are sufficient to obtain the purposes of the invention, that is, to provide a hydrocarbon component that provides satisfactory miscibility of the lubricant oils and that enables the refrigerant blend to remain nonflammable both as formulated and after leakage from the system.

### EXAMPLES

In the preferred embodiments, the percentage of hydrocarbon component in both the liquid and vapor phases does not exceed about five (5) weight percent of the blend. If the hydrocarbon percentage exceeds this amount in either of these phases, the refrigerant may become flammable under some circumstances. Fractionation studies were undertaken to determine the percentage change of the components during leakage of the refrigerant. The results are provided in Tables 1 and 2.

### Example 1

Fractionation effect. The fractionation effect was determined by a computer simulation using the National Institute of Standards and Technology (NIST) program REFPROP v 6.0. The program simulated the fractionation under the following conditions: A 25 pound (11.3 kg) test cylinder maintained at a temperature of 77° F. (25° C.) and filled to 80% capacity. The refrigerant was slowly leaked from the cylinder until depleted. Table 1 provides the results of the fractionation test on an inventive blend according to Blend 1, and having the components in the proportions listed in the Table. Table 2 provides the results on a comparative blend having pure propane as the sole hydrocarbon component.

TABLE 1
test using propane/isobutane as hydrocarbon component
Percent liquid remaining

| | 100% | 90% | 80% | 70% | 60% | 40% | 20% |
|---|---|---|---|---|---|---|---|
| Liquid | | | | | | | |
| R-600a | 1.50 | 1.52 | 1.54 | 1.56 | 1.58 | 1.58 | 1.49 |
| R-290 | 1.47 | 1.24 | 1.03 | 0.83 | 0.63 | 0.30 | 0.08 |
| R-125 | 48.88 | 47.78 | 46.54 | 45.11 | 43.20 | 38.20 | 29.17 |
| R-134a | 44.17 | 45.69 | 47.35 | 49.20 | 51.59 | 57.56 | 67.77 |
| R-32 | 3.98 | 3.76 | 3.54 | 3.30 | 3.01 | 2.36 | 1.48 |
| Vapor | | | | | | | |
| R-600a | 1.30 | 1.35 | 1.39 | 1.44 | 1.49 | 1.60 | 1.66 |
| R-290 | 2.69 | 2.20 | 1.93 | 1.77 | 1.37 | 0.93 | 0.39 |
| R-125 | 58.41 | 57.78 | 57.01 | 56.04 | 54.64 | 50.49 | 41.57 |
| R-134a | 31.67 | 33.00 | 33.28 | 35.67 | 37.78 | 43.14 | 53.89 |
| R-32 | 5.93 | 5.67 | 5.39 | 5.09 | 4.71 | 3.85 | 3.67 |

TABLE 2
test using propane as only hydrocarbon component
Percent liquid remaining

| | 100% | 90% | 80% | 70% | 60% | 40% | 20% |
|---|---|---|---|---|---|---|---|
| Liquid | | | | | | | |
| R-290 | 2.95 | 2.53 | 2.09 | 1.67 | 1.26 | 0.61 | 0.16 |
| R-125 | 48.89 | 47.95 | 46.75 | 45.35 | 43.53 | 38.72 | 29.54 |
| R-134a | 44.19 | 45.73 | 47.59 | 49.64 | 52.14 | 58.21 | 68.72 |
| R-32 | 3.98 | 3.79 | 3.57 | 3.34 | 3.07 | 2.46 | 1.58 |
| Vapor | | | | | | | |
| R-290 | 7.02 | 6.27 | 5.42 | 4.55 | 3.62 | 1.94 | 0.60 |
| R-125 | 57.24 | 56.88 | 56.34 | 55.62 | 54.55 | 51.03 | 42.34 |
| R-134a | 30.00 | 31.32 | 32.96 | 34.83 | 37.15 | 43.11 | 54.36 |
| R-32 | 5.74 | 5.53 | 5.27 | 5.00 | 4.68 | 3.93 | 2.71 |

As demonstrated by the data in Table 1, when a hydrocarbon component comprising R-290 (propane) and R-600a (isobutane) is used, the total amount of the hydrocarbon component does not vary appreciably as refrigerant is leaked from the system, and does not vary in a manner such that either the liquid phase or the vapor phase would be flammable at any point throughout the leakout. As demonstrated by the data in Table 2, when using only propane as the hydrocarbon component in the refrigerant blend (in this case at 2.95 wt % in the starting blend), the vapor phase during leakout initially has a propane percentage of over 7%, which exceeds the flammability limit. In contrast, the percentage of the propane/isobutane hydrocarbon mixture shown in Table 1 remains below 4% throughout the entire leak procedure. A blend having in excess of about 5.5 to 6% hydrocarbon will generally be flammable when mixed with the remaining components.

### Example 2

Refrigerating effect. A computer simulation test was performed utilizing Blend 1, Blend 2, R-22 and commercially available R-22 replacements to compare the refrigerating effect and coefficient of performance of the various refrigerants. The results are provided in Table 3.

TABLE 3

| Refrigerant | Refrigerating effect | Coefficient of performance |
|---|---|---|
| R-22 | 1.00 | 2.44 |
| R-407C | 0.98 | 2.21 |
| R-410A | 1.04 | 2.52 |
| R-417 | 0.93 | 2.07 |
| Blend 1¹ | 1.01 | 2.45 |
| Blend 2² | 1.00 | 2.43 |

¹R-32/R-125/R-290/R-134a/R-600a (4/47/1.5/46/1.5)
²R-125/R-290/R-134a/R-600a(52/1.5/45/1.5)

As evident from Table 3, the refrigerating effect and coefficient of performance of the inventive refrigerant blends is equal to or slightly higher than R-22, and markedly better than all other commercially available R-22 replacements except R-410A. However, R-410A is not compatible with existing refrigeration equipment used in R-22 refrigeration systems, and its use requires replacement of the existing equipment. As described above, the inventive blends tested in this simulation include some components in common with R-417, but did not include butane. Rather, the inventive blends comprised a combination of isobutane and propane as the hydrocarbon component. Blend 1 also included a minor amount of R-32. The inventive blends demonstrated increased refrigerating effect and coefficient of performance when compared to R-417, and yet are non-flammable, non-toxic, non-ozone-depleting, and miscible with existing compressor lubricating oils of the type used with R-22.

### Example 3

Performance testing. The time required to reduce the air temperature inside an insulated box at a defined starting temperature provides a good estimate of the refrigerating capacity of the refrigerant blend, and also provides a good basis to compare the performance of the blend to the performance of R-22 with other commercially available blends that are compatible with the refrigeration system. A refrigerant blend according to the present invention was prepared with the following percentages of components:

(a) R-134a in an amount of 45.5 wt. %;

(b) R-125 in an amount of 48 wt. %;

(c) R-32 in an amount of 4 wt %; and

(d) a hydrocarbon component in an amount of 1.5 wt. % R600a and 1 wt. % R-290, based on the weight of the entire blend.

An air conditioner supplied with a Copeland Corporation low temperature condensing unit (Model #CLAL-0300) and having a cooling capacity of 5780 BTU/hr (1694 watts/hr) at −40° F. (−40° C.) was installed inside a cooling box. The cooling box had dimensions of 8 ft.×10 ft.×7 ft. (2.4 m.×3.0 m.×2.1 m.) and was lined with a 4-inch (10.2 cm.) layer of polyurethane. The air conditioner was connected to a scanner to record the temperature and pressure inside the box at different points during a test cycle. The refrigerant blend described above was charged in the testing unit, and the air conditioner was continuously run to reduce the temperature in the cooling box from 80° F. (26.6° C.) to 40° F. (4.4° C.). The same procedure was followed for comparative refrigerants R-22, R-407C and R-417A. The test was then repeated, except in this case the air conditioner was continuously run to reduce the temperature in the cooling box from 80° F. (26.6° C.) to 0° F. (−17.7° C.). Comparative tests cooling from 80° F. (26.6° C.) to 0° F. (−17.7° C.) were also run for R-22, R-407C and R-417A. Finally, the test was again repeated, except that in this case the air conditioner was continually run until it reached its maximum cooling, i.e., the lowest obtainable temperature. The test results are provided below:

| | Time required | Time required | Time required |
|---|---|---|---|
| | to cool from | to cool from | to cool from |
| | 80° F. to 40° F. | 80° F. to O° F. | 80° F. to lowest |
| Refrigerant | (min.) | (min.) | temp. (min.) |
| Inventive blend | 5.5 | 47 | 210¹ |
| R-22 | 4.5 | 37 | 360² |
| R-407C | 5.0 | 52 | 330³ |
| R-417A | 5.0 | 52 | 240⁴ |

1. Lowest temperature reached was −14° F.
2. Lowest temperature reached was −20° F.
3. Lowest temperature reached was −14.7° F.
4. Lowest temperature reached was −12.5° F.

As illustrated above, the inventive blend was shown to have better cooling capacity than either R-407C or R-417A when cooling from 80° F. (26.6° C.) to 0° F. (−17.7° C.), but slightly less than that of R-22. The time required to cool to the lowest obtainable temperature was much less with the inventive blend than the other refrigerants tested. The inventive blend had operating pressure similar to R-22, which indicates that no major design changes are required to improve performance.

### Example 4

Performance testing. Further performance testing was performed in a room utilizing a Bryant® split system air conditioner (Model 59OANX024OOOAAAA) manufactured to use R-22 refrigerant. Tests were performed on a blend according to Blend 1 and a blend according to Blend 2. Comparative tests were run on R-22 and R-417A. For all runs, the ambient temperature was 82° F. (27.8° C.), and the room was heated 90° F. (32.2° C.) before the air conditioner was turned on. The air conditioner was run continuously until the room was cooled to 70° F. (21.1° C.). The readings provided below for each refrigerant were taken when the room temperature had cooled to 75° F. (23.9° C.).

| | Blend 1¹ | Blend 2² | R-22 | R-417A |
|---|---|---|---|---|
| Suction pressure | 71 | 71 | 72 | 64 |
| (psig) | | | | |
| Head pressure | 266 | 259 | 257 | 244 |
| (psig) | | | | |
| Amperage | 12 | 11.6 | 11.7 | 10.9 |
| Evaporator temp. | 38 | 38 | 40 | 44 |
| (° F.) | | | | |
| Time to cool to | 34 | 36 | 36 | 42 |
| 70° F. (min) | | | | |
| Discharge air | 62 | 63 | 63 | 66 |
| temp. (° F.) | | | | |

1. R-32/R-125/R-290/R-134a/R-600a (4/47/1.5/46/1.5)
2. R-125/R-290/R-134a/R-600a (52/1.5/45/1.5)

As demonstrated by the above data, and using the unit with R-22 installed as the baseline, the unit charged with Blend 1 shows increased capacity over R-22 in that it had lower evaporator temperatures, and cooled the room from 90° F. (32.20 C) to 70° F. (21.1° C.) two minutes faster than the unit charged with R-22. The unit charged with Blend 2 showed very similar operating characteristics to the R-22 unit in that it had slightly lower evaporator temperatures, but took the same time to cool the room from 90° F. (32.2° C.) to 70° F. (21.1° C.). The unit charged with R-417A showed less refrigerating capacity than each of the other refrigerant blends tested in that the evaporator and discharge temperatures were higher and the time to cool the room to 70° F. (21.1° C.) was four minutes longer.

It is to be understood that the above-described blends are merely illustrative embodiments of the principles of this invention, and that other compositions and methods for using same in refrigeration and air conditioning systems may be devised by those skilled in the art, without departing from the spirit and scope of the invention. It is therefore intended that the foregoing detailed description be regarded as illustrative rather than limiting.

1. A refrigerant composition comprising:
(a) about 20-60 weight percent R-134a;
(b) about 40-70 weight percent R-125;
(c) about 1-10 weight percent R-32; and
(d) about 1-8 weight percent of a hydrocarbon component, the hydrocarbon component comprising one or more hydrocarbons selected from Group A and one or more hydrocarbons selected from Group B, wherein Group A comprises hydrocarbon refrigerants having a boiling point lower than the boiling point of R-134a and Group B comprises hydrocarbon refrigerants having a boiling point higher than the boiling point of R-134a.

2. The composition of claim 1, comprising 30-50 weight percent R-134a, 45-60 weight percent R-125, 2-6 weight percent R-32, and 1-5 weight percent of said hydrocarbon component, wherein the hydrocarbons of Group A comprise one or more hydrocarbons selected from the group consisting of R-290, R-1270, R-170 and R-50, and the hydrocarbons of Group B comprise one or more hydrocarbons selected from the group consisting of R-600a, R-600 and R-601.

3. The composition of claim 1, comprising 45-50 weight percent R-134a, 45-50 weight percent R-125, 3-5 weight percent R-32, and 1-4 weight percent of the hydrocarbon component, wherein the Group A hydrocarbon comprises R-290 and the Group B hydrocarbon comprises R-600a.

4. The composition of claim 1, comprising 1-2 weight percent R-290 and 1-2 weight percent R-600a.

5. The composition of claim 4, comprising about 1.5 weight percent R-290 and about 1.5 weight percent R-600a.

6. A refrigerant composition comprising:
(a) about 20-60 weight percent R-134a;
(b) about 40-70 weight percent R-125;
(c) about 1-8 weight percent of a hydrocarbon component, the hydrocarbon component comprising one or more hydrocarbons selected from Group A and one or more hydrocarbons selected from Group B, wherein Group A comprises hydrocarbon refrigerants having a boiling point lower than the boiling point of R-134a and Group B comprises hydrocarbon refrigerants having a boiling point higher than the boiling point of R-134a.

7. The composition of claim 6, comprising 30-50 weight percent R-134a, 45-60 weight percent R-125, and 1-5 weight percent of said hydrocarbon component, wherein the hydrocarbons of Group A comprise one or more hydrocarbons selected from the group consisting of R-290, R-1270, R-170 and R-50, and the hydrocarbons of Group B comprise one or more hydrocarbons selected from the group consisting of R-600a, R-600 and R-601.

8. The composition of claim 6, comprising 40-50 weight percent R-134a, 50-55 weight percent R-125, and 1-4 weight percent of the hydrocarbon component, wherein the Group A hydrocarbon comprises R-290 and the Group B hydrocarbon comprises R-600a.

9. The composition of claim 6, comprising 1-2 weight percent R-290 and 1-2 weight percent R-600a.

10. The composition of claim 9, comprising about 1.5 weight percent R-290 and about 1.5 weight percent R-600a.

11. A method for producing refrigeration in a refrigeration system comprising employing as a refrigerant a composition comprising about 20-60 weight percent R-134a; about 40-70 weight percent R-125; about 1-10 weight percent R-32; and about 1-8 weight percent of a hydrocarbon component, the hydrocarbon component comprising one or more hydrocarbons selected from Group A and one or more hydrocarbons selected from Group B, wherein Group A comprises hydrocarbon refrigerants having a boiling point lower than the boiling point of R-134a and Group B comprises hydrocarbon refrigerants having a boiling point higher than the boiling point of R-134a.

12. The method of claim 11, wherein the refrigerant composition comprises 30-50 weight percent R-134a, 45-60 weight percent R-125, 2-6 weight percent R-32, and 1-5 weight percent of said hydrocarbon component, wherein the hydrocarbons of Group A comprise one or more hydrocarbons selected from the group consisting of R-290, R-1270, R-170 and R-50, and the hydrocarbons of Group B comprise one or more hydrocarbons selected from the group consisting of R-600a, R-600 and R-601.

13. The method of claim 11, wherein the refrigerant composition comprises 45-50 weight percent R-134a, 45-50 weight percent R-125, 3-5 weight percent R-32, and 1-4 weight percent of the hydrocarbon component, wherein the Group A hydrocarbon comprises R-290 and the Group B hydrocarbon comprises R-600a.

14. The method of claim 11, wherein the refrigerant composition comprises 1-2 weight percent R-290 and 1-2 weight percent R-600a.

15. The method of claim 14, wherein the refrigerant composition comprises about 1.5 weight percent R-290 and about 1.5 weight percent R-600a.

16. A method for producing refrigeration in a refrigeration system comprising employing as a refrigerant a composition comprising about 20-60 weight percent R-134a; about 40-70 weight percent R-125; and about 1-8 weight percent of a hydrocarbon component, the hydrocarbon component comprising one or more hydrocarbons selected from Group A and one or more hydrocarbons selected from Group B, wherein Group A comprises hydrocarbon refrigerants having a boiling point lower than the boiling point of R-134a and Group B comprises hydrocarbon refrigerants having a boiling point higher than the boiling point of R-134a.

17. The method of claim 16, wherein the refrigerant composition comprises 30-50 weight percent R-134a, 45-60 weight percent R-125, and 1-5 weight percent of said hydrocarbon component, wherein the hydrocarbons of Group A comprise one or more hydrocarbons selected from the group consisting of R-290, R-1270, R-170 and R-50, and the hydrocarbons of Group B comprise one or more hydrocarbons selected from the group consisting of R-600a, R-600 and R-601.

18. The method of claim 16, wherein the refrigerant composition comprises 40-50 weight percent R-134a, 50-55 weight percent R-125, and 1-4 weight percent of the hydrocarbon component, wherein the Group A hydrocarbon comprises R-290 and the Group B hydrocarbon comprises R-600a.

19. The composition of claim 16, wherein the refrigerant composition comprises 1-2 weight percent R-290 and 1-2 weight percent R-600a.

20. The method of claim 19, wherein the refrigerant composition comprises about 1.5 weight percent R-290 and about 1.5 weight percent R-600a.
